(19) United States
(12) Patent Application Publication
(10) Pub. No.: US 2015/0217522 A1
(43) Pub. Date: Aug. 6, 2015

(54) METHODS AND DEVICES FOR IMPROVING USABLE LIFE OF WEARABLE SURFACES

(71) Applicants: Vikrant Ragula, Salt Lake City, UT (US); Kaniska Ragula, Salt Lake City, UT (US); Ragula Bhaskar, Salt Lake City, UT (US)

(72) Inventors: Vikrant Ragula, Salt Lake City, UT (US); Kaniska Ragula, Salt Lake City, UT (US); Ragula Bhaskar, Salt Lake City, UT (US)

(21) Appl. No.: 14/531,318

(22) Filed: Nov. 3, 2014

Related U.S. Application Data
(60) Provisional application No. 61/935,777, filed on Feb. 4, 2014.

(51) Int. Cl. B29C 73/02; B05C 21/00; B05D 3/00; B60C 11/00; B05D 5/06; B05D 1/36; B29C 73/24; B29C 73/26; B05C 1/00; B05D 3/12

(52) U.S. Cl. CPC B29C 73/02; B05C 1/00; B05C 21/00; B05D 3/002; B05D 3/12; B05D 5/06; B05D 1/36; B29C 73/24; B29C 73/26; B60C 11/00

(57) ABSTRACT

Embodiments of the present invention relate to extending the usable life of one or more wearable surfaces, such as the treads of a tire or the surface of a conveyor, for example. According to example embodiments of the invention, the treads of a tire or the surface of a conveyor are cleaned and a polymer is applied to the one or more wearable surfaces so as to rebuild and recondition the tire or conveyor thereby extending the usable life of the tire or conveyor. An aggregate or colorant may be added to the polymer to improve its performance or to identify that the tire has been treated in such way. The colorant may also be applied for cosmetic or other identification purposes. The polymer may also change or optimize the tire's tread pattern for changes in weather, for example.

### CROSS-REFERENCE TO RELATED APPLICATIONS

This application claims the benefit of, and priority to, U.S. Provisional Patent Application No. 61/935,777, filed Feb. 4, 2014, the contents of which are incorporated herein by reference in their entirety.

### BACKGROUND OF THE INVENTION

1. The Field of the Invention

Embodiments of the present invention are relevant to extending the usable life of surfaces that tend to wear out over a period of time due to the use of the application that they are subject to. For example, the surfaces may be subject to a friction surface during use thereby causing wear. The wearable surface can include a flexible polymer, such as the wearable surface of a tire or conveyor belt.

Several embodiments also relate to a color indicator as to the wear characteristics of the surfaces subject to wear. Several embodiments also relate to a cosmetic application to the wearable surfaces or surfaces adjacent thereto. Several embodiments include combinations of such embodiments in addition to other aspects discussed herein or a combination thereof.

2. The Relevant Technology

The tread of a tire, for example, wears out due to its inherent wear as a result of driving a vehicle. As another example, a conveyor surface, or sifting surface wears out as it carries, or separates, abrasive material such as dirt, and especially rock. While it is relatively easy to replace a tire, conveyor replacement, for example, can run into several tens of thousands of dollars, and both can be very time consuming and discarding such can be an environmental hazard as requiring further energy to do so. Quite simply, tire recycling, sifting, and conveyor contact surface replacement pose an important environmental issue. Literally, hundreds of millions of tires worldwide are rendered useless when their contact surfaces, in the form of treads with respect to tires, wear out.

In a small portion in the case of tires, the tires are re-treated using conventional retreading techniques where the old treads are removed, and then new rubber is laid over the area, which is then vulcanized using hot molds. A vast majority, and ever increasing number, of vehicle owners prefer to buy new tires instead of the retreads, due to concerns that the treads may come off when driving causing a sever safety concern.

The conventional retreading technique involves removing the tread of a tire and replacing it with new rubber molded on to the carcass of the old tire. While this works in many cases, it is an expensive way to reuse the tire. In addition, it is often common to see numerous retreaded portions on the side of the road where the new treads tend to fall off, especially in hot conditions. This is not only wasteful due to the process and expense of the retread, but also extremely dangerous to the individuals in the vehicle losing the retread and also other drivers there behind. Moreover, at some point someone must clean up this lost retread material further creating waste of time and risk to such person.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

These and other limitations are overcome by embodiments of the invention which relate to systems and methods for improving the usable life of wearable surfaces. This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter. The systems can include means for coating the wearable surface that comes in contact with the contact surface as discussed below.

And, the methods can include acts for coating the wearable surface that come into contact with the contact surface as discussed below. There are also disclosed means for applying a cosmetic surface to the sidewalls or tires for identification thereof, for example as environmentally beneficial means of reconditioning a tire or at the desire of the tire's owner.

Embodiments of the present invention related to a method of extending the usable life of one or more wearable surfaces that wear out over a period of time due to the use of the application that they are subject to. The method can further include cleaning the wearable surface. The method can further include using an applicator, applying a polymer to the one or more wearable surfaces so as to rebuild and recondition the one or more wearable surfaces thereby extending the usable life of the one or more wearable surfaces such that they may increase the use and application that they are subject to.

In some embodiments, the wearable surfaces can include the tread of a tire and the tire is no longer usable prior to application of the polymer to the treads of the tire but the usable life of the tire is extended due to the application of the polymer to the tread of the tire.

Embodiments of the invention can also relate to systems for extending the usable life of wearable surfaces of a tread of a tire that wear out over a period of time due to the use of the application that the tire is subject to. The system can further include means for cleaning the wearable surfaces of the tire. The system can also include means for applying a polymer to the wearable surfaces of the tire so as to rebuild and recondition the one or more wearable surfaces of the tire thereby extending the usable life of the one or more wearable surfaces of the tread of the tire such that they may increase the use of the tire and application that the tire is subject to.

As discussed in further detail below, most of the tread wear is on the outer part of the tire that comes in contact with the road. It may be more preferable to repair just this crucial portion of the tire as opposed the laborious and energy consuming requirements of retreading a tire. A technique, related methods, and systems are presented herein below in subsequent sections to address this, as well as other, issues.

In the instance of conveyors, conventionally the conveyor belt has to be simply replaced as the wear surface wears out, resulting large pieces of conveyors generally being discarded. When conveyors are used to transport abrasive material such as rock the surface of the conveyor tends to abrade causing the conveyor belt to wear out. Extended wear weakens the belt, and causes it to fail and potentially also leads to safety concerns.

In addition to such methods and systems, techniques can be used to visually indicate a wear level or wear characteristic of the tire or conveyer. Moreover, techniques can also be used to apply a cosmetic aspect to tires or other surfaces, for example.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIGS. 1A, 1B, 1C, 1D, 1E, 1F and 1G show and describe various systems and methods for extending the usable life of one or more wearable surfaces that wear out over a period of time due to the use of the application that they are subject to, such as the wearable surfaces of the treads of one or more tires. A similar embodiment can be applied to a conveyor belt which could be applied manually or automatically. Further embodiments include the application of a cosmetic polymer for cosmetic purposes or wear indication.

### DETAILED DESCRIPTION OF THE PREFERRED EMBODIMENTS

Embodiments of the invention relate to coating wearable surfaces, such as worn surfaces of conveyors and tires, with one or more strongly adhesive compounds where at least one of which includes a high wear resistance to the material that comes in contact with the contact surface. In such examples, the invention includes a way to clean the treads alone, and then coat the treads with new substantially strong material. The coating can be done in multiple layers using means for coating the wearable surface, such as:

1. A roller coating mechanism that coats the tire in thin layers so that the residual treads on the tire are covered by the coat while the recesses do not receive the coating, thus increasing the depth of the tread grooves and thickness of the tire tread. For example, in this embodiment, a roller picks up a thin layer of a compound and applies it to the tire treads only. This application can be repeated so as to build up the tread as opposed to replacing the tread. This rolling application can be repeated at a predetermined rate so that the second layer, and so on, is applied at an appropriate time based on the cure rate of the first layer. Certain additives may also be used in the material of the applied layers, or varied from layer to layer, so as to achieve an optimum performance, adhesion, and wear characteristic. Moreover, a width-wise, composite layering may also be used depending on the application and weather or particular use.

Examples of the coating compound of the various layers can include a fast drying compound, and/or a 2 part epoxy, and/or a UV curable and/or a heat curable compound. In this example, the mixture is applied and the tire is then cured using any curing technique, such as heat, UV, drying, chemical reaction, or a combination thereof. Then a new coating is applied, and the process is repeated.

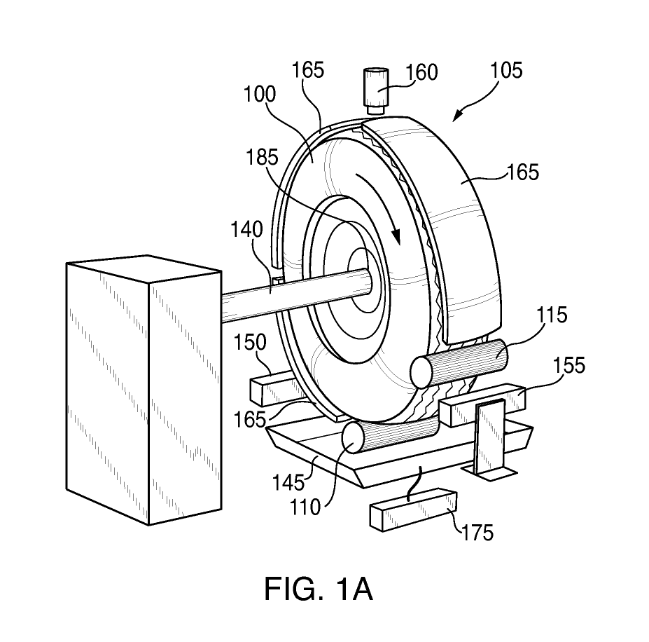

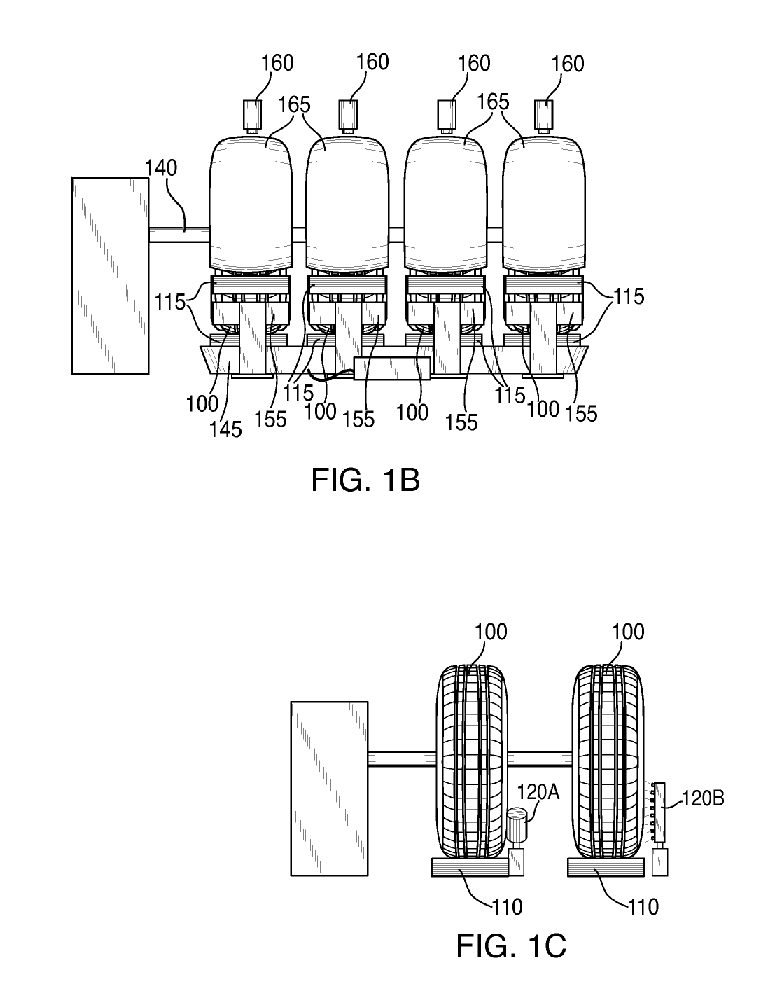

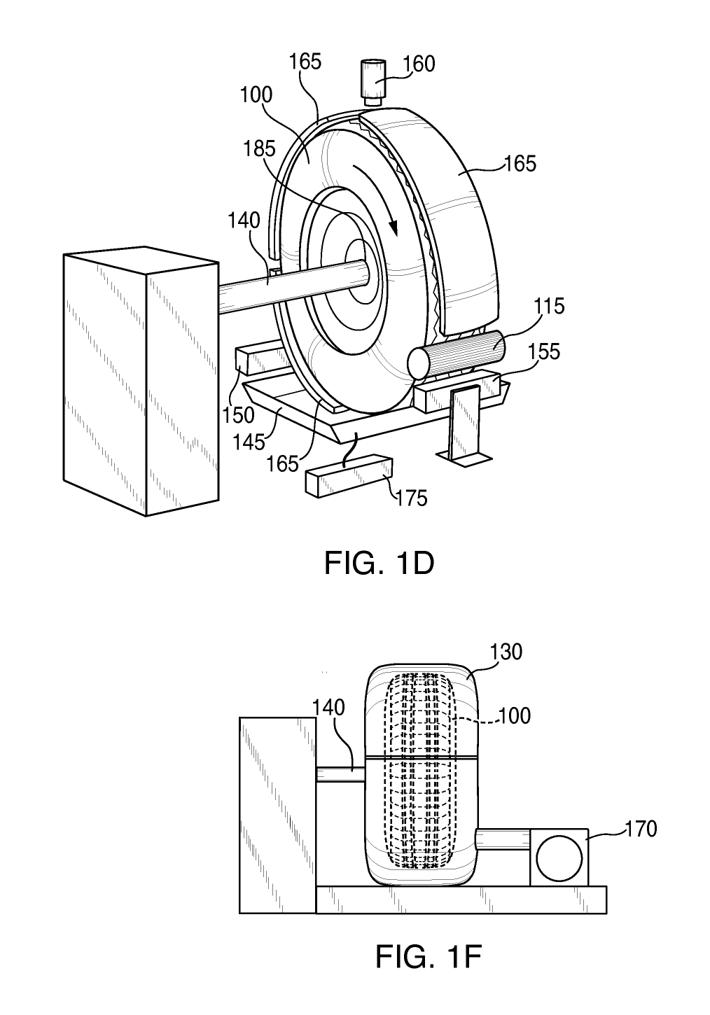

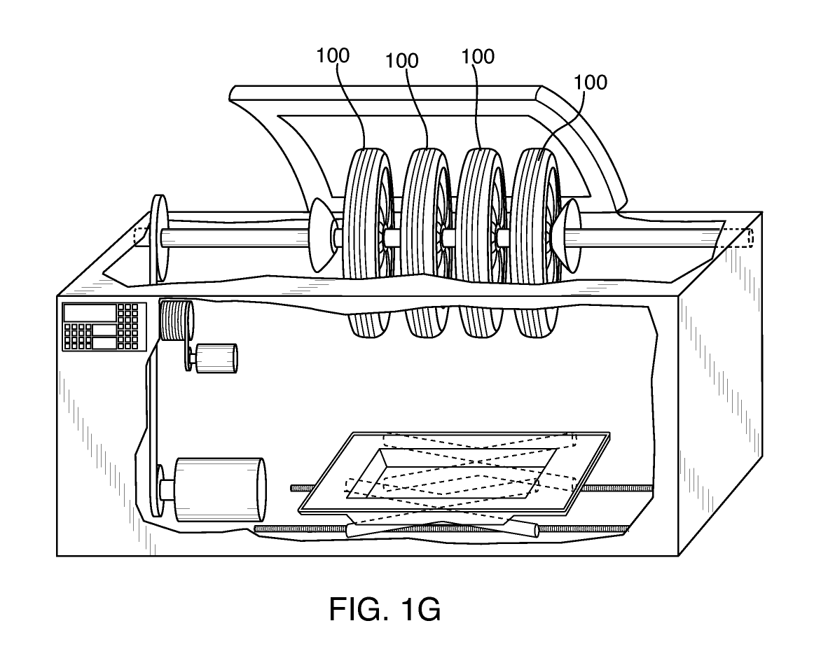

For example, referring to FIG. 1A, a tire 100 can be mounted on a rotating device 105 and then lowered, raised, or otherwise placed in contact with a roller coater 110. The tire 100 is then turned and the roller coater 110 then applies the coating on the tire 100. The tire 100 may be singularly treated. Referring to FIGS. 1B and 1G there can be several tires 100 connected to a mount and treated in parallel by a large coater 110 that spans the width of the wearable surfaces of all of the tires 100 simultaneously, or multiple individual coaters 110 individually biased against the individual tires 100 wearable surface, for example. Moreover, the tires 100 can be treated in series where once one tire 100 is treated it is allowed to cure, for example using the methods discussed above, while a second tire 100 is treated before a subsequent layer is applied to the first tire 100, and so on.

In some embodiments, by controlling the thickness of the roller 110 nap and providing a predetermined shape to the roller 110, then the roller 100 can apply the compound on only the raised tread areas of the tire 100, for example, or creates a three dimensional design as the wearable surface is built-up. Regarding tires, 100 this builds up the tread thickness to the desired level. Then the tire 100 can be cured using any number of currently available techniques either on the rotating mount or in a batch process. If additional layers need to be added, the process can be repeated.

The compound being applied needs to be able to be strongly adhered to the tire 100 treads. To this purpose, means for cleaning the tire, such as a revolving or stationary wire brush, or other cleaning device 115, can be included in the systems and methods prior to application of the material applied to the treads of a tire 100. This can be achieved by using an abrasive wire brush, fixed or rotating sanding pads, and/or chemical techniques, for example. This cleaning device 115 removes dirt and can also treat the tread surface so that the new chemicals being applied adhere strongly to the tread. Similarly, indentations grooves or other “key” or small “dovetail” mechanical locking features may be produced in the worn tread to further adhere and secure the added layers to the worn surface.

The compound can of various combinations of the following:

A. Adhesive: for example one part or two part adhesives.

B. Fillers and flexibility providers: rubber or other synthetic compounds that provide similar characteristics.

C. Abrasives: for example silica, aluminum oxide, and other abrasives that reduce wear of the new applied treads.

The compounds can also mixed in various proportions to reflect the mechanical properties required of the tread.

Colorants that provide color to the material added to the tire tread can also be used to make it show that the tire is an environmentally cleaner product. Colorant can also be used to show tread wear and can be added to the applied material. When the applied compound wears out, then the old black tire tread will be revealed, thus reminding the vehicle owner that they should to re-coat the tread once again. By applying the tread wear compound in a regular manner a tire's 100 life can be increased significantly, eliminating, or at least prolonging, the need for new tires 100, and thus reducing cost, as well as the environmental impact.

As shown in FIG. 1C, according to several embodiments, the colorant and coated material may also, or solely, be added to the sidewall of the tire 100. For example, means for applying a colorant to the sidewall of the tire 100, such as a second roller 120A or spray 120B technique can be used for this purpose. This may be used for cosmetic purposes, for example, to match the color of the wheels of the vehicle or color of the vehicle. This may also be used for new or used tires 100 to reflect a source of the tire 100, as a trademark, distinctive product design identifying a source of the tire, or source of the vehicle, the vehicle's owner, or simply as a preference of the car owner. As discussed above, the roller may be shaped so as to build up the polymer in a particular shape. Similarly, the sidewall roller 120A may also be likewise configured to produce a desired color scheme, texture, or design.

There can also be hand held sprays that can be administered by a person by directly spraying it on the tire treads or using a roller, especially of new tires similar to the spray 120 shown in FIG. 1C. Similarly, an automated, or manual, system can be used to recondition a conveyor or other wearable surface.

For large tires such as tractor and mining tires 100 where the entire tire 100, including the recessed space between treads, also comes in contact with rough non-paved roads the recessed space also is often abraded. To ensure a full coat, including the portion between the treads, the tire 100 can be partially submerged in a trough as shown in FIG. 1D containing the compound after being cleaned, and the excess dirt removed.

Alternately, the compound can also be applied using a roller or a brush, or sprayed on the surface of the tire 100. For example, the method can include a paint roller method of application of the coating to farm and mining type tires 100, where the entire tire 100 needs to be coated. The color can be the same color as that of the tire 100, or a different color, such as blue or green visually indicating the environmentally friendly product as previously discussed. In such embodiments, the compound can be selectively applied to the sidewalls as well where such damage thereto is encountered. In an automated embodiment, an electro-optical system could also be used to identify and apply such compound to such damaged areas. In some embodiments, a special spectrum of light may be used to more clearly identify potentially damaged areas. And, the colorant applied can also be selected to more readily reflect potential future damaged areas.

The color change can also serve to advertise the product by bringing attention to the product. For instance, when people see a tread of a different color, then they will inquire about the particular tire 100, and this helps the company attract attention to its product and its benefits as discussed above. A logo or name re-pasted on the tire 100, as discussed above, can indicate that the tire re-tread was reconditioned in an environmentally friendly manner and was of benefit to the environment as opposed to simply being discarded. The colorant can also be used for other identification purposes as discussed above. The colorant can also be used to identify the number of times the tire 100 has had compound applied or a particular thickness or layer of the compound applied that has been worn off. For example the first time a tire is reconditioned a first colorant may be used and the second time a tire is reconditioned a second colorant different from the first colorant may be used, and so forth.

The savings to the user can be significant. For instance, a new tire 100 can cost upwards of $100, while a mining tire 100 can cost tens of thousands of dollars to replace. By applying this invention, the need to replace tires can be significantly reduced to a fraction of the cost.

Regarding examples of addition of wear resistance surfaces to new tires 100:

Currently due to the nature of manufacturing, tire compounds have to be created and then molded under pressure. Layers of rubber are built up over a tire blank 125 and then placed in a curing oven 130 as shown in FIG. 1F. The tie is then pressed with a bladder against a mold under heat and pressure.

Currently, the layers of rubber are of the same material. Referring again to FIGS. 1A-1G, examples of the invention also include adding the last few layers on the periphery of the tire 100 that contains modifiers such as abrasives that reduce tire wear. It is possible to create a layer of rubber (natural or synthetic) greater, or less than, the thickness of the treads and place that layer over the circumference of the rubber blank before it is molded. When the tire is subsequently molded, then the modified layer forms the molded layer with the tread. By this method it is possible to create various characteristics of the tire 100 from a tread perspective. This can include special wear resistant modifiers such as silica, aluminum oxide or glass, whether as a fiber or fines. When the blank is placed in the mold and molded, then the modified layer of rubber forms the tread. Using this process, it is possible to increase the life of the tread or change the characteristics of the tires compared to the rest of the tire body such as the sides.

The tire compound can also be applied to new tires in order to change the tread characteristics or extend the life of the tire 100. A variant of the compound, for example there can be one coating optimized for summer, one coating for winter, and/or a coating for rain. The winter coating can have a different coating which assists in better grip. The better grip can be provided by addition of more flexible filler such as crumb rubber or synthetic rubber. The winter coating may have additional additives to assist in ice and snow, for example, such as a different tread pattern and/or a composite compound with filling material.

The method can also include a step for strengthening the treads when making a new tire 100 by placing a harder compound strips over the usual rubber compounds when building the tire. The thickness of the modified, harder compound can also be according to the tread depth. Then the new tire can be molded, the tread molding occurs on the harder outer surface of the tire, will become the tread, thus providing for a harder tread.

One embodiment of a tire coating system including means for coating a tire can be as follows:

Referring again to FIG. 1A, the tire coating system can include an arm 140 that holds the tire 100, or multiple tires 100, for example as shown in FIGS. 1B and 1G, in place. The arm 140 is raised away from a trough 145 and applicator 110 and the tire(s) 100 are inserted and tightened. Then the arm 140 is lowered to the height necessary so that the tire is in direct and aligned contact with the coating roller 110, or multiple coating rollers 110.

A speed regulated motor assembly 105 is coupled with the arm 140 to rotate the tire(s) 100. The motor speed can be varied depending on the type and diameter of the tire 100, or the type of material being used for coating, or if the tire 100 is merely being prepped for receiving a coating.

The coating system can include a trough 145 with a metering roller and a coating roller. The compound can be mixed and placed in the trough 145. The trough 145 may be fixed or can be slid in and out. This is of use, especially when the cleaning roller or brush 115 is turned on, and it is desirable to keep the dust and dirt from the coating compounds.

Another version that is especially useful when some time sensitive ingredients have to be mixed is a spreader 150. The spreader 150 can include a mixing chamber that mixes the compounds as it passes through the spreader 150 and is then applied on the tire 100. The additives can include fillers, or a two part epoxy, for example. The spreader 150 can be of a disposable variety also that is removable from, and connectable to, the trough 145.

A cleaning device 115 such as a brush or a sander that rotates at a different speed than the tire 100 can be used. This can also be in the form of a belt sander and/or an air pressure driven grit sand blast system to loosen up any loose dirt. The cleaning device 115 can also operate to create tiny dents in the tire to make it rough and increase the surface area, or create locking features, for adhesion of the compound.

A dust and/or debris collector 155 can be placed adjacent to, or right around the cleaning device 115, to remove dust and tire particles. The system may also include an air suction device close to the tire that sucks up any bridging that occurs when the compound is spread over very narrow tread slits in the tire. However, this bridging is generally expected to break off by itself as the tire flexes.

A depth measuring device 160 can be placed near the tire and used to determine the depth of the coating. It is also possible to connect a feedback mechanism to the depth measuring device 160 so that the coating can be stopped and the arm 140 raised when the desired depth is achieved. The depth measuring device 160 can be mechanical or optical as is known in metrology measurement technologies.

The system can also include a bank of curing devices, such as heating elements, UV light or other techniques that are presently available or may be available in the future to cure the compound used for coating. The curing system can be disposed around the dispensing frame to cure the tire. The curing system can be a bank of heaters, UV lamps, chemical and other current, and to be developed, curing systems. And, the curing system 165 may be curved such that it closely matches the profile of the tires so that the curing more likely to be evenly distributed is as shown in FIG. 1A.

The system can also include a separate circular dryer device as shown in FIG. 1F with a heating element 130 that may also be used in situations where a shop applies the coating, and needs to dry the coating before the customer departs the parking lot. The device can be a circular device with heating elements 130, and/or a hot air blower 170 that can be hooked to the tires, and the heated air dries the coating. Then the heating device may be removed off the tire 100. The system can also include a color system 175 that mixes the color with the applied polymer for a similar purpose.

The applicator 110 can also include a roller 110 that is shaped so that its contours match the tire 100 width being coated as previously discussed. For example, the applicator 110 can have shorter brushes, or felt, in the center to match the bulge in tires 110 and is longer at the edges where the tire tends to curve towards the sides of the tire 110. Such matching further ensures that an evenly distributed coating across the width of the tire is applied. The system can also include multiple applicators 110 set at various angles to cover the treads fully instead of a single applicator. There can also be an uneven application of coating, for example, so that more coating is applied at the center, and less on the sides where the wear is less apparent. The coating may also be non-uniform across the width of the tire compensating for a particular wear pattern. This may be accomplished using multiple rollers or controlling the distribution of the compound to the roller. In some instances the use of the trough 145 may be eliminated and the compound may be delivered to the roller from a central location of the roller from a reservoir or sprayed on the roller.

Another embodiment of the application of compound is to mount the vehicle on a raised platform and hand apply the coating after cleaning the tires using a brush or a cleaning fluid and then curing the applied material using a dryer, or other curing unit as discussed herein, to cure the coating. This method works particularly well with large oversized tires similar to that previously discussed.

Another embodiment of the applicator includes a peel and stick version where the compound is presented in a roll of non-stick paper, wrapped around the wheel, and then the paper removed. The bond can be strengthened by using a roller to press the compound against the wheel. This method works particularly well with motorcycle and smaller tires, for example.

The embodiments described herein may employ control of the systems using a special purpose or general-purpose computer including various computer hardware or software modules programmed to cause the system to perform such methods and can be included within or be sold separately with or without the systems described.

Similarly embodiments within the scope of the present invention also include computer-readable media for carrying or having computer-executable instructions or data structures stored thereon for controlling such systems.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope. The embodiments described herein may include the use of a special purpose or general-purpose computer including various computer hardware or software modules, as discussed in greater detail below.

Embodiments within the scope of the present invention also include computer-readable media for carrying or having computer-executable instructions or data structures stored thereon for controlling such systems. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method of extending the usable life of one or more worn wearable surfaces that wear out over a period of time due to the use of the application that they are subject to, comprising:
cleaning the worn wearable surfaces; and
using an applicator to apply a polymer to the one or more worn wearable surfaces so as to rebuild and recondition the one or more worn wearable surfaces thereby extending the usable life of the one or more worn wearable surfaces such that they may increase the use and application that they are subject to.

2. The method of claim 1, wherein the worn wearable surfaces include the worn wearable surfaces of treads of a tire and the tire is no longer usable prior to application of the polymer to the worn wearable surfaces of the treads of the tire but the usable life of the tire is extended due to the application of the polymer to the worn wearable surface of the treads of the tire.

3. The method of claim 2, wherein the polymer is only applied to the worn wearable tread surfaces of the treads of the tire but is not applied to areas in-between the treads which are not subject to the same wear characteristics as the worn wearable surfaces of the treads of the tire.

4. The method of claim 3, wherein the polymer is applied to the worn wearable surfaces of the treads of the tire by a roller.

5. The method of claim 4, wherein the application of the polymer by the roller is performed by an automated system including an arm that engages the roller with the worn wearable surfaces of the tire treads.

6. The method of claim 4, wherein the application of the polymer is manually applied to the worn wearable surfaces of the treads of the tire using the roller by a person.

7. The method of claim 2, wherein the worn wearable surface to which the polymer is applied includes portions of the tire between the tire's treads and the polymer is applied to the portion of the tire between the treads due to wear to the portions of the tire between the tire's treads.

8. The method of claim 7, wherein the tire is dipped in a trough carrying the polymer then allowed to cure.

9. The method of claim 1, wherein the polymer includes a colorant that makes the polymer applied to the wearable surface a different color than the worn wearable surfaces.

10. The method of claim 9, wherein the colorant indicates a wear characteristic of the polymer during subsequent use of the wearable surfaces of the application that they are subject to.

11. The method of claim 9, wherein the colorant identifies that the wearable surfaces have had the polymer applied.

12. The method of claim 2, wherein the application of the polymer changes a tread characteristic of the tire.

13. The method of claim 12, wherein the tread characteristic includes an additive included in the applied polymer.

14. The method of claim 12, wherein the tread characteristic is selected based on the use of the application that the tire is subject to.

15. The method of claim 12, wherein the tread characteristic is selected based on weather conditions of which the tire is subject to.

16. The method of claim 2, wherein the polymer is mixed with an abrasive.

17. The method of claim 16, wherein the abrasive includes silica or aluminum oxide.

18. The method of claim 2, wherein multiple layers of the polymer are applied to the wearable surfaces of the tire and allowed to individually cure between application of layers so as to continuously build up the thickness of the treads of the tire.

19. A tire reconditioned according to the method of claim 2, where the worn wearable surfaces of the tire include the treads of the tire, wherein the tire further comprises the polymer adhered to the worn wearable surfaces of the treads of the tire and the treads of the tire are the original treads of the tire.

20. The method of claim 1, wherein the worn wearable surfaces include the worn wearable surface of a conveyor.

21. The method of claim 20, wherein the worn wearable surfaces of the conveyor are worn from contact with dirt and/or rock.

22. A system for extending the usable life of worn wearable surfaces of a tread of a tire that wear out over a period of time due to the use of the application that the tire is subject to, comprising:
means for cleaning the worn wearable surfaces of the tire; and
means for applying a polymer to the worn wearable surfaces of the tire so as to rebuild and recondition the worn wearable surfaces of the tire thereby extending the usable life of the worn wearable surfaces of the tread of the tire such that they may increase the use of the tire and application that the tire is subject to.

23. The system of claim 22, wherein the means for applying the polymer to the worn wearable surfaces of the tire includes a roller by which successive layers of the polymer are applied to the worn wearable surfaces by the roller.

24. The system of claim 23, wherein the roller is shaped to conform to a curvature of the tire surface so that the polymer is applied evenly in thickness over the worn wearable surfaces of the treads of the tire regardless of whether the treads are on the side or in the center of the tire.

25. The system of claim 22, wherein the system includes a mount by which polymer is simultaneously applied to worn wearable surfaces of the treads of multiple tires which are simultaneously attached to the mount.

26. The system of claim 22, wherein the system includes an arm to which a tire is to be mounted and a trough holding the polymer.

27. The system of claim 22, wherein the means for applying a polymer to the wearable surfaces of the tire includes a roller and the means for cleaning the wearable surfaces of the tire includes a wire or sanding device located prior to the roller in the direction of rotation of the tire.

28. The system of claim 26, wherein the arm is configured to lower the tire into the trough such that the treads of the tire are immersed in the polymer.

29. A tire reconditioned using the system of claim 22, wherein the worn wearable surfaces of the tire include the treads of the tire, wherein the tire further comprises the polymer adhered to the worn wearable surfaces of the treads of the tire and the treads of the tire are the original treads of the tire.
